(19) United States
(12) Patent Application Publication
(10) Pub. No.: US 2024/0363012 A1
(43) Pub. Date: Oct. 31, 2024

(54) SYSTEMS AND METHODS FOR AVIATION RUNWAY INCURSION AVOIDANCE

(71) Applicant: Purdue Research Foundation, West Lafayette, IN (US)

(72) Inventors: Luigi Raphael Iboleon Dy, West Lafayette, IN (US); John Mott, Lafayette, IN (US)

(73) Assignee: Purdue Research Foundation, West Lafayette, IN (US)

(21) Appl. No.: 18/643,517

(22) Filed: Apr. 23, 2024

Related U.S. Application Data
(60) Provisional application No. 63/461,613, filed on Apr. 25, 2023.

(51) Int. Cl. G08G 5/00

(52) U.S. Cl. CPC G08G 5/0082; G08G 5/0026

(57) ABSTRACT

A runway incursion avoidance system includes a plurality of surveillance sub-systems that are configured to detect whether an approach and a surface of an aviation runway is currently occupied or will soon be occupied by an object, such as an aircraft, vehicle, pedestrian, wild animal, or other foreign object. The surveillance sub-systems each broadcast one or more occupancy states of the aviation runway. The runway incursion avoidance system further includes a plurality of runway status light sub-systems that control one or more runway status lights depending on the occupancy states broadcast by the surveillance sub-systems. The runway status lights may include Departure and Approach Warning Lights (DALs) to indicate runway status to aircraft taking off from the runway and landing on the runway, or Runway Entrance Lights (RELs) to indicate runway status to aircraft, vehicles, and pedestrians preparing to cross a runway.

This application claims the benefit of priority of U.S. provisional application Ser. No. 63/461,613, filed on Apr. 25, 2023 the disclosure of which is herein incorporated by reference in its entirety.

### FIELD

The device and method disclosed in this document relates to aviation runways and, more particularly, to runway incursion avoidance.

### BACKGROUND

Unless otherwise indicated herein, the materials described in this section are not admitted to be the prior art by inclusion in this section.

Runway incursions are events in which an aircraft, vehicle, or pedestrian inappropriately enters or occupies a runway surface. Runway incursions have long been a problem in aviation safety, leading to accidents such as the infamous 1977 Tenerife airport disaster, the deadliest accident in aviation history, and the collision of Japan Airlines flight 516 with a Japan Coast Guard aircraft on Jan. 2, 2024. An overwhelming majority of runway incursion accidents since 2010 have involved general aviation aircraft at non-towered airports, where air traffic control services are unable to provide another layer of traffic separation and collision avoidance.

Numerous technologies and other solutions have been proposed to prevent runway incursions. However, such solutions have had limited impact on the number of runway incursions and runway incursion-related accidents. Particularly, while many solutions have been proposed, few have seen widespread adoption due to prohibitive costs and complexities. Moreover, most efforts in preventing runway incursions have been focused on towered airports.

Since most runway incursion accidents have involved general aviation aircraft at non-towered airports and previously proposed technologies have seen limited adoption due to costs and complexity, there is a clear need for a low-cost and low-complexity runway incursion avoidance system. Preferably, such a runway incursion avoidance system should be applicable to both towered and non-towered airports alike to achieve widespread adoption.

### SUMMARY

A system for aviation runway safety is disclosed. The system comprises a plurality of surveillance modules, each surveillance module including a respective processor and a respective transmitter. The respective processor of each surveillance module is configured to independently determine a respective prediction of an occupancy state of an aviation runway, the occupancy state indicating whether a defined region of the aviation runway at least one of (i) is currently occupied by an object and (ii) will be occupied by an object within a predetermined amount of time. The respective processor of each surveillance module is further configured to operate the respective transmitter to broadcast the respective prediction of the occupancy state. The system further comprises a plurality of runway status light modules, each runway status light module including a respective processor, a respective receiver, and a respective runway status light. The respective processor of each runway status light module is configured to operate the receiver to receive the respective prediction of the occupancy state from each of the plurality of surveillance devices. The respective processor of each runway status light module is further configured to operate the respective runway status light depending on the respective prediction of the occupancy state from each of the plurality of surveillance devices.

### BRIEF DESCRIPTION OF THE DRAWINGS

The foregoing aspects and other features of the system and method are explained in the following description, taken in connection with the accompanying drawings.

FIG. 1 shows components of a runway incursion avoidance system.

FIG. 2A shows an exemplary embodiment of a computer-vision surveillance sub-system.

FIG. 2B shows a camera configuration for a small runway.

FIG. 3 shows an exemplary embodiment of an ADS-B surveillance sub-system.

FIG. 4A shows an exemplary embodiment of a runway status light sub-system.

FIG. 4B shows a runway status light configuration for a small aviation runway.

FIG. 4C shows an exemplary fixture having two runway status lights.

FIG. 4D shows a fixture installed adjacent to existing aviation runway signage.

FIG. 4E shows an embodiment in which high intensity runway status lights are located across the runway and abeam any installed approach lighting.

FIG. 5A shows one example in which an aviation runway is divided in to three detection volumes.

FIG. 5B shows a further example in which the surface of an aviation runway is subdivided in to four detection volumes.

FIG. 6A shows a flow diagram for a method for operating an ADS-B surveillance subsystem to monitor one or more detection volumes.

FIG. 6B shows a flow diagram for a further method for operating an ADS-B surveillance subsystem to monitor one or more detection volumes, including forecasting future occupancy of other detection volumes.

FIG. 7A shows a flow diagram for a method for operating a computer-vision surveillance subsystem to monitor a runway approach detection volume.

FIG. 7B shows a flow diagram for a further method for operating a computer-vision surveillance subsystem to monitor a runway approach detection volume, including forecasting future occupancy of other detection volumes.

FIG. 8A shows a flow diagram for a method for operating a computer-vision surveillance subsystem to monitor a runway surface detection volume.

FIG. 8B shows a flow diagram for a further method for operating a computer-vision surveillance subsystem to monitor a runway surface detection volume, including forecasting future occupancy of other detection volumes.

FIG. 9 shows a flow diagram for a method for operating a surveillance sub-system to broadcast occupancy states of a detection volume.

FIG. 10 shows a flow diagram for a method for operating a runway status light sub-system to provide runway status indication.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### System Overview

A runway incursion avoidance system is disclosed herein that is safe, affordable, flexible, and expandable. The disclosed system advantageously reduces critical runway incursions at airports. The system is low cost and requires no buy-in from aircraft pilots and operators, and should be easy to maintain, in line with current goals of the Federal Aviation Administration for runway incursion solutions. As a result of such affordability, the disclosed system could be adopted by general aviation airports without control towers, where most runway incursion accidents have occurred since 2010, to supplement see-and-avoid and radio communications.

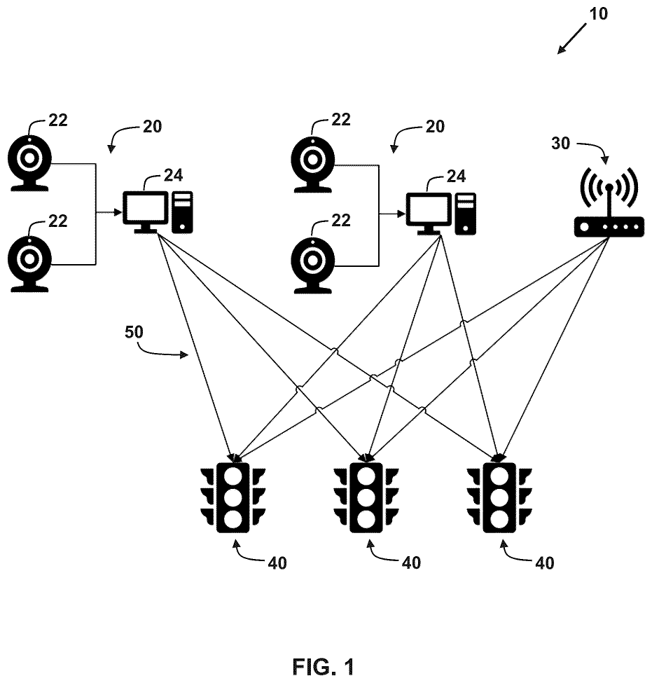

FIG. 1 shows components of a runway incursion avoidance system 10. The runway incursion avoidance system 10 comprises a plurality of surveillance sub-systems 20, 30, which may also be referred to as surveillance devices or surveillance modules, that are configured to detect whether an approach or a surface of an aviation runway is currently occupied or will soon be occupied by an object, such as an aircraft, vehicle, pedestrian, wild animal, or other foreign object. The surveillance sub-systems 20, 30 each broadcast one or more occupancy states of the aviation runway.

The runway incursion avoidance system 10 further comprises a plurality of runway status light sub-systems 40, which may also be referred to as runway status light devices or runway status light modules, that control one or more runway status lights depending on the occupancy states broadcast by the surveillance sub-systems 20, 30. Each runway status light sub-system 40 includes a computing device configured to receive the predicted occupancy states of the aviation runway from plurality of surveillance sub-systems 20, 30 and to operate an arbitrary number of individual runway status lights, which may be installed at various locations near the runway for various purposes. For example, the runway status lights may include Departure and Approach Warning Lights (DALs) to indicate runway status to aircraft taking off from the runway and landing on the runway, and/or Runway Entrance Lights (RELs) to indicate runway status to aircraft, vehicles, and pedestrians preparing to cross a runway.

In at least some embodiments, the surveillance sub-systems 20, 30 broadcast the occupancy states of the aviation runway to the runway status light sub-systems 40 using a wireless radio communication protocol, such as Low Power Wide Area Network (LPWAN) or, more particularly, Long Range Wide Area Network (LoRaWAN). The use of wirelessly controlled status lights further provides flexibility for the runway incursion avoidance system 10 to be used with other surveillance methods (including those in development) to meet the needs of different airports and improve with technological advances. However, it should be appreciated that in alternative embodiments, the surveillance sub-systems 20, 30 may be configured to broadcast the occupancy states of the aviation runway to the runway status light sub-systems 40 using a wired communication protocol via a wired network that interconnects the modules of the runway incursion avoidance system 10.

The plurality of surveillance sub-systems 20, 30 may take a variety of different forms. In the illustrated embodiment, the runway incursion avoidance system 10 includes two computer-vision surveillance sub-systems 20, as well as a single ADS-B surveillance sub-system 30. However, the runway incursion avoidance system 10 may include any number of computer-vision surveillance sub-systems 20 and ADS-B surveillance sub-system 30, as well as incorporate further types of surveillance sub-systems that similarly operate to broadcast predicted occupancy states of an approach or a surface of an aviation runway.

The runway incursion avoidance system 10 detects potential conflicts with respect to particular detection volumes depending on whether any one of the surveillance sub-systems 20, 30 indicates that an object, such as an aircraft, vehicle, pedestrian, wild animal, or other foreign object, is occupying the relevant detection volume. Simultaneous detection through both the computer-vision surveillance sub-systems 20 and the ADS-B surveillance sub-system 30 is not necessary. This allows the system to function with non-ADS-B equipped aircraft, and when the computer vision system fails to detect an aircraft. Thus, the ADS-B and computer vision components are redundant for detecting aircraft.

Relevant conflicts are advantageously differentiated from irrelevant conflicts based on the aircraft's direction of travel and trends in altitude. For example, departing aircraft should not trigger a detection once airborne, while landing aircraft should trigger a detection while still in the air. Likewise, aircraft moving away from a runway intersection should not trigger detection (if detailed surface detection volumes are used).

The computer-vision surveillance sub-systems 20 each comprise an arbitrary number of cameras 22 suitably arranged to have a view of the approach and/or a surface of an aviation runway. The computer-vision surveillance sub-systems 20 each further include a computing device 24 or controller configured to process video feeds received from the camera(s) 22 using computer-vision techniques to detect whether an approach and a surface of an aviation runway is currently occupied or will soon be occupied by an object, such as an aircraft, vehicle, pedestrian, wild animal, or other foreign object.

In contrast to the computer-vision surveillance sub-systems 20, the ADS-B surveillance sub-system 30 includes an Automatic Dependent Surveillance-Broadcast (ADS-B) receiver configured to receive traffic information from ADS-B equipped aircraft and ground vehicles. The ADS-B surveillance sub-system 30 further includes a computing device configured to process the traffic information to detect whether an approach and a surface of an aviation runway is currently occupied or will soon be occupied by an aircraft or vehicle. It should be appreciated that, in some embodiments, the ADS-B receiver is configured to receive traffic information using a variety of other surveillance and communications systems, such as Mode S. Accordingly, references herein to ADS-B should be understood to also include any other suitable technologies for receiving traffic information from aircraft and ground vehicles.

The surveillance sub-systems 20, 30 each operate independently from one another to predict the occupancy states of the aviation runway. Likewise, each runway status light sub-system 40 can operate independently based on predicted occupancy states received from any arbitrary number and configuration of surveillance sub-systems 20, 30. Additionally, the runway status light sub-systems 40 also operate using individual control logic corresponding to the particular purpose(s) and installation location(s) of the connected runway status light(s).

Additionally, even though, each of the surveillance sub-systems 20, 30 and runway status light sub-systems 40 is described as having an individual computing device, it should be appreciated that, in some configurations, different sub-systems of the runway incursion avoidance system 10 may share a central computing device.

It should be appreciated that the runway incursion avoidance system 10 can be implemented in a highly flexible and easily expandable manner. Particularly, the runway incursion avoidance system 10 is expandable in that additional status lights can be easily deployed as the airport grows, and as budgets can handle, without suffering from cost inefficiencies.

The runway incursion avoidance system 10 promises to provide a practical solution to further improve the safety of the aviation system. This runway incursion avoidance system 10 supplements see-and-avoid and radio communications at non-towered airports and reduces the probability and corresponding risk of an aircraft collision as a result of a runway incursion. Moreover, the runway incursion avoidance system 10 complements the FAA's “right site-right size” approach, by providing another option for airports. With a focus on non-towered airports, it also provides a solution to airports not currently in line to receive new technologies being developed by the FAA and its partners.

Additionally, it should be appreciated that, by incorporating surveillance sub-systems 20, 30 that adopt different approaches to occupancy prediction, the runway incursion avoidance system 10 achieves greater reliability and redundancy. Moreover, compared to ADS-B only surveillance, the runway incursion avoidance system 10 is robust against non-cooperative aircraft (aircraft without functioning ADS-B transmitters).

A further advantage of the runway incursion avoidance system 10 is the ability to alert all traffic to possible runway conflicts, including aircraft, vehicles, pedestrians, wild animals, or other foreign objects. Thus, the runway incursion avoidance system 10 tackles both pilot deviations and vehicle/pedestrian deviations that lead to runway incursions while requiring no buy-in from anyone but the airport management and operator. The runway incursion avoidance system 10 should also be intuitive and easily seen as it is in the airport environment, where pilots, drivers, and pedestrians should be looking while navigating/driving around an airport, and not on a kneeboard or interior panel.

Finally, although not described in great detail herein, the runway incursion avoidance system 10 can also be adapted to provide operations counting features for non-towered airports. Particularly, each time an aircraft is detected as landing on the aviation runway, the runway incursion avoidance system 10, e.g., one of the surveillance sub-systems 20, 30, can increment a count of aircraft arrivals of the airport for a relevant measurement period. Likewise, each time an aircraft is detected as taking off from the aviation runway, the runway incursion avoidance system 10, e.g., one of the surveillance sub-systems 20, 30, can increment a count of aircraft departures of the airport for a relevant measurement period.

### Computer-Vision Surveillance Sub-Systems

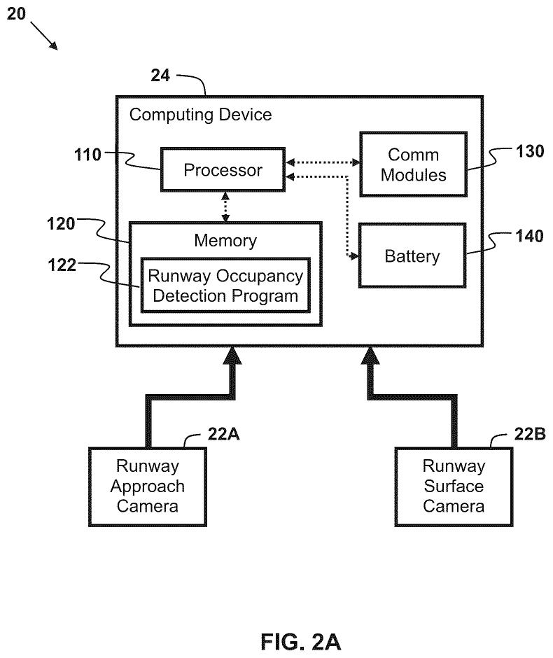

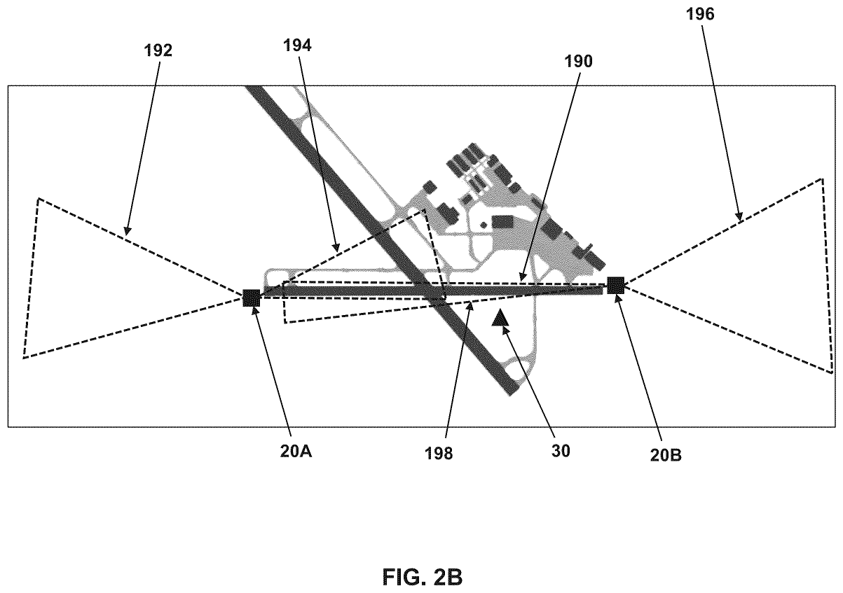

FIG. 2A shows an exemplary embodiment of a computer-vision surveillance sub-system 20. The computing device 24 of the computer-vision surveillance sub-system 20 comprises a processor 110, a memory 120, at least one network communications module 130, and a battery 140 (or other power source). It will be appreciated that the illustrated embodiment of the computing device 24 is only one exemplary embodiment and is merely representative of any of various manners or configurations of a computer or controller, or any other computing devices that are operative in the manner set forth herein.

The processor 110 is configured to execute instructions to operate the computing device 24 to enable the features, functionality, characteristics and/or the like as described herein. To this end, the processor 110 is operably connected to the memory 120, the network communications module 130, and the cameras 22. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 24 to perform various operations described herein. The memory 120 may be any type of device capable of storing information accessible by the processor 110, such as a memory card, ROM, RAM, hard drives, discs, flash memory, or any of various other computer-readable media serving as data storage devices, as will be recognized by those of ordinary skill in the art.

The network communications module 130 may comprise one or more transceivers, modems, processors, memories, oscillators, antennas, or other hardware conventionally included in a communications module to enable communications with various other devices in the runway incursion avoidance system 10. Particularly, the network communications module 130 generally includes at least a wireless radio transceiver configured to broadcast information using a wireless communication protocol, such as Low Power Wide Area Network (LPWAN) or, more particularly, Long Range Wide Area Network (LoRaWAN). In some embodiments, the network communications module 130 may also include one or more cellular modems configured to communicate with wireless telephony networks, such as a GSM radio.

The battery 140 or other power source (not shown) is configured to power the various components within the computing device 24, as well as cameras 22A, 22B. In one embodiment, the battery of the computing device 24 is a rechargeable battery configured to be charged via an attached solar panel (not shown).

In at least some embodiments, the memory 120 stores program instructions of a runway occupancy detection program 122 that is executed to process video from the cameras 22A, 22B to detect whether an approach and a surface of an aviation runway is currently occupied or will soon be occupied by an object, such as an aircraft, vehicle, pedestrian, wild animal, or other foreign object.

With continued reference to FIG. 2A, the computer-vision surveillance sub-system 20 may include an arbitrary number of cameras 22 connected to the computing device 24 thereof, which are used to predict the occupancy states of an approach and/or a surface of an aviation runway. In the illustrated embodiment, the computer-vision surveillance sub-system 20 incorporates two different cameras, a runway approach camera 22A and a runway surface camera 22B. The runway approach camera 22A is arranged near the aviation runway and oriented such that it has a view of an approach of the aviation runway. As used herein the term “approach” of an aviation runway refers to a volume of space through which an aircraft will descend toward an aviation runway prior to landing on the surface of the aviation runway. In general, the approach is a volume of space that extends immediately past an end of an aviation runway. Similarly, the runway surface camera 22B is arranged near the aviation runway and oriented such that it has a view of a surface of the aviation runway. Depending on the size of the aviation runway, the computer-vision surveillance sub-system 20 may include additional cameras 22 and/or the runway incursion avoidance system 10 may include further computer-vision surveillance sub-systems 20 incorporating additional cameras 22.

FIG. 2B shows a camera configuration for a small aviation runway 190. Two computer-vision surveillance sub-system 20A, 20B are installed off-center and close to the end of the thresholds of the aviation runway 190. Particularly, a first computer-vision surveillance sub-system 20A is installed at a first end of the aviation runway 190 and a second computer-vision surveillance sub-system 20B is installed at a second end of the aviation runway 190, which is opposite the first end. The first computer-vision surveillance sub-system 20A has a runway approach camera having a first coverage area 192 within which objects can be detected in an approach to the aviation runway 190. The first computer-vision surveillance sub-system 20A has a runway surface camera having a second coverage area 192 within which objects can be detected on a portion of the surface of the aviation runway 190. The second computer-vision surveillance sub-system 20B has a runway approach camera having a third coverage area 196 within which objects can be detected in an approach to the aviation runway 190. Finally, the second computer-vision surveillance sub-system 20A has a runway surface camera having a fourth coverage area 198 within which objects can be detected on a portion of the surface of the aviation runway 190.

### ADS-B Surveillance Sub-System

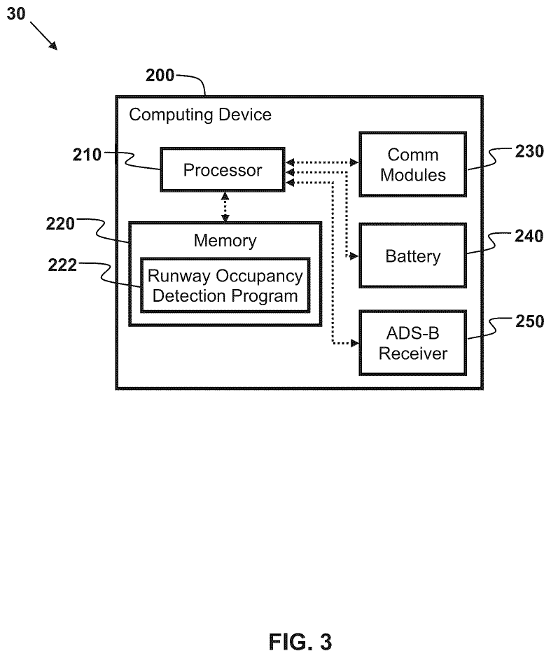

FIG. 3 shows an exemplary embodiment of an ADS-B surveillance sub-system 30. A computing device 200 of the ADS-B surveillance sub-system 30 comprises a processor 210, a memory 220, at least one network communications module 230, and a battery 240 (or other power source). Additionally, the computing device 200 includes or is otherwise in communication with an ADS-B receiver 250. It will be appreciated that the illustrated embodiment of the computing device 200 is only one exemplary embodiment and is merely representative of any of various manners or configurations of a computer or controller, or any other computing devices that are operative in the manner set forth herein.

The processor 210 is configured to execute instructions to operate the computing device 200 to enable the features, functionality, characteristics and/or the like as described herein. To this end, the processor 210 is operably connected to the memory 220, the network communications module 230, and the ADS-B receiver 250. The processor 210 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 210 may include a system with a central processing unit, graphics processing units, multiple processing units, dedicated circuitry for achieving functionality, programmable logic, or other processing systems.

The memory 220 is configured to store data and program instructions that, when executed by the processor 210, enable the computing device 200 to perform various operations described herein. The memory 220 may be any type of device capable of storing information accessible by the processor 210, such as a memory card, ROM, RAM, hard drives, discs, flash memory, or any of various other computer-readable media serving as data storage devices, as will be recognized by those of ordinary skill in the art.

The network communications module 230 may comprise one or more transceivers, modems, processors, memories, oscillators, antennas, or other hardware conventionally included in a communications module to enable communications with various other devices in the runway incursion avoidance system 10. Particularly, the network communications module 230 generally includes at least a wireless radio transceiver configured to broadcast information using a wireless communication protocol, such as Low Power Wide Area Network (LPWAN) or, more particularly, Long Range Wide Area Network (LoRaWAN). In some embodiments, the network communications module 230 may also include one or more cellular modems configured to communicate with wireless telephony networks, such as a GSM radio.

The battery 240 or other power source (not shown) is configured to power the various components within the computing device 200, including the ADS-B receiver 250. In one embodiment, the battery of the computing device 200 is a rechargeable battery configured to be charged via an attached solar panel (not shown).

The ADS-B receiver 250 is configured to receive traffic information from any ADS-B-Out equipped aircraft and ground vehicles that are within range of the ADS-B surveillance sub-system 30. The traffic information received from each respective aircraft or ground vehicle includes, for example, aircraft/vehicle identification information, a ground speed of the aircraft/vehicle, a ground track (direction of travel) of the aircraft/vehicle, and a GPS location (latitude and longitude) of the aircraft/vehicle. It should be appreciated that, in some embodiments, the ADS-B receiver 250 is configured to receive traffic information using a variety of other surveillance and communications systems, such as Mode S. Accordingly, references herein to ADS-B should be understood to also include any other suitable technologies for receiving traffic information from aircraft and ground vehicles.

In at least some embodiments, the memory 220 stores program instructions of a runway occupancy detection program 222 that is executed to process the traffic information received from the ADS-B receiver 250 to detect whether an approach or a surface of an aviation runway is currently occupied or will soon be occupied by an aircraft or vehicle.

With reference again to FIG. 2B, the ADS-B surveillance sub-system 30 may be installed near the aviation runway 190 with the appropriate antennas installed at an elevated position, with line-of-sight visibility of the airport's surfaces, and departure/approach paths, so as to receive traffic information from any ADS-B equip aircraft or vehicles. It should be appreciated that although only a single ADS-B surveillance sub-system 30 is illustrated, the runway incursion avoidance system 10 may include multiple ADS-B surveillance sub-systems 30.

### Runway Status Light Sub-Systems

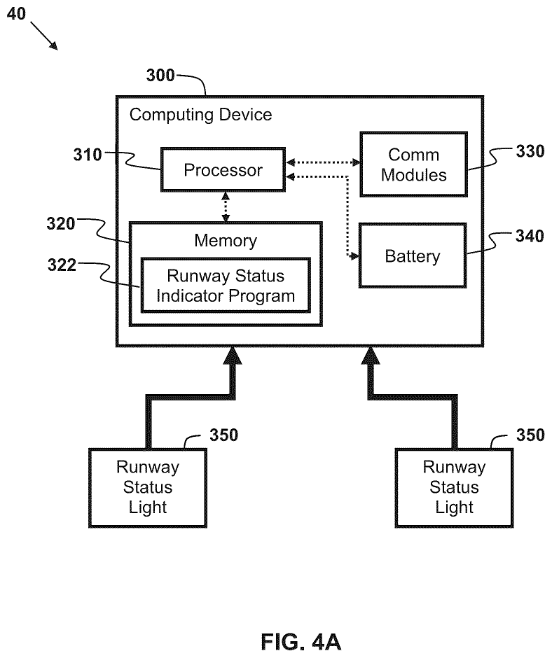

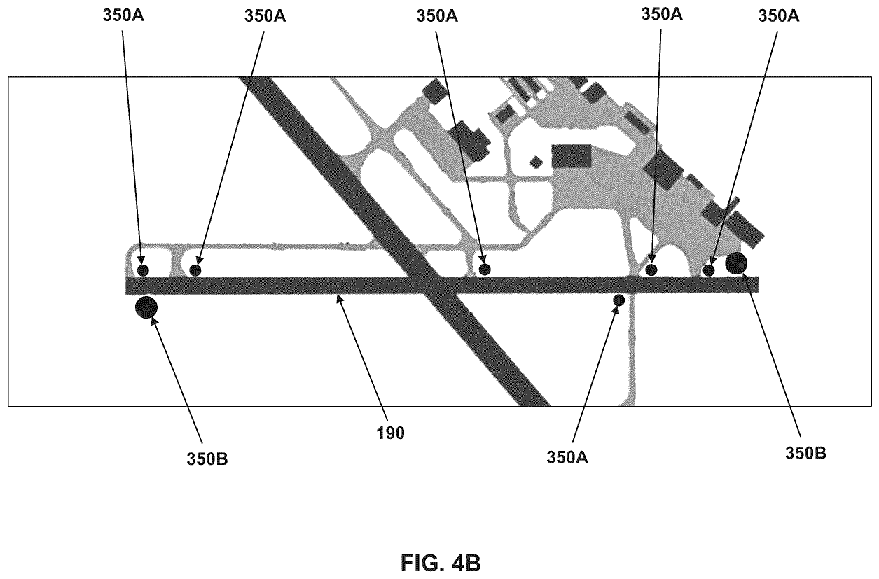

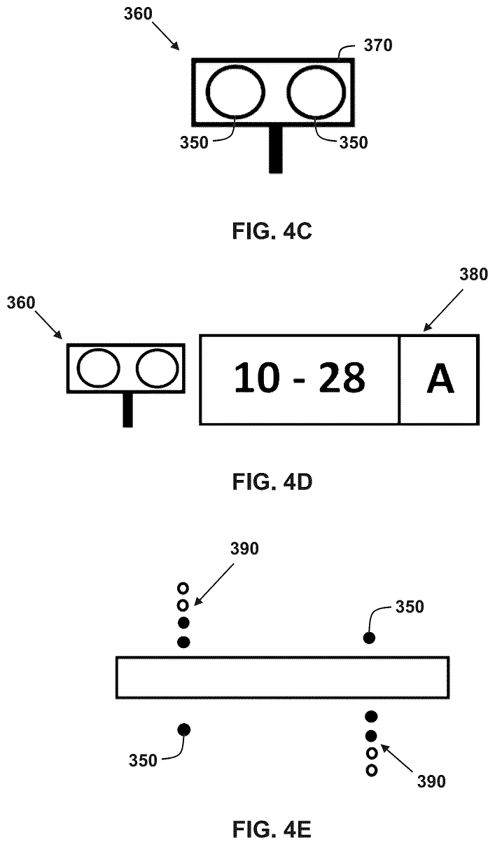

FIG. 4A shows an exemplary embodiment of a runway status light sub-system 40. A computing device 300 of the runway status light sub-system 40 comprises a processor 310, a memory 320, at least one network communications module 330, and a battery 340 (or other power source). Additionally, the computing device 300 includes or is otherwise in communication with one or more runway status lights 350. It will be appreciated that the illustrated embodiment of the computing device 300 is only one exemplary embodiment and is merely representative of any of various manners or configurations of a computer or controller, or any other computing devices that are operative in the manner set forth herein.

The processor 310 is configured to execute instructions to operate the computing device 300 to enable the features, functionality, characteristics and/or the like as described herein. To this end, the processor 310 is operably connected to the memory 320 and the network communications module 330. The processor 310 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 310 may include a system with a central processing unit, graphics processing units, multiple processing units, dedicated circuitry for achieving functionality, programmable logic, or other processing systems.

The memory 320 is configured to store data and program instructions that, when executed by the processor 310, enable the computing device 300 to perform various operations described herein. The memory 320 may be any type of device capable of storing information accessible by the processor 310, such as a memory card, ROM, RAM, hard drives, discs, flash memory, or any of various other computer-readable media serving as data storage devices, as will be recognized by those of ordinary skill in the art.

The network communications module 330 may comprise one or more transceivers, modems, processors, memories, oscillators, antennas, or other hardware conventionally included in a communications module to enable communications with various other devices in the runway incursion avoidance system 10. Particularly, the network communications module 330 generally includes at least a wireless radio transceiver configured to receive information using a wireless communication protocol, such as Low Power Wide Area Network (LPWAN) or, more particularly, Long Range Wide Area Network (LoRaWAN). In some embodiments, the network communications module 330 may also include one or more cellular modems configured to communicate with wireless telephony networks, such as a GSM radio.

The battery 340 or other power source (not shown) is configured to power the various components within the computing device 300, as well as the runway status lights 350. In one embodiment, the battery of the computing device 300 is a rechargeable battery configured to be charged via an attached solar panel (not shown).

With continued reference to FIG. 4A, the runway status light sub-system 40 may include an arbitrary number of runway status lights 350 connected to the computing device 300 thereof, which are operated depending on the occupancy states broadcast by the surveillance sub-systems 20, 30. In the illustrated embodiment, the runway status light sub-system 40 incorporates two different runway status lights 350. The runway status lights 350 may be installed in a common light fixture or installed at separate nearby locations.

In at least some embodiments, the memory 320 stores program instructions of a runway status indicator program 322 that is executed to operate the runway status lights 350 in a predetermined manner depending on the occupancy states broadcast by the surveillance sub-systems 20, 30. In some embodiments, the processor 310 operates the runway status lights 350 in concert with one another according to the same logic. Alternatively, the processor 310 operates the runway status lights 350 according to different logic and in such a way as to indicate different information about the status of the aviation runway.

The runway incursion avoidance system 10 may include an arbitrary number of runway status light sub-systems 40, each including an arbitrary number of runway status lights 350. In this way, the runway status light sub-systems 40 may be installed at a variety of different locations along a runway to provide various safety functions. In at least some embodiments, the runway status light sub-systems 40 includes runway status lights 350 that are operated to provide an indication of runway occupancy to aircraft, vehicles, and pedestrians on the ground, which are referred to herein as Runway Entrance Lights (RELs). In general, RELs would be installed at ground entrances to the aviation runway to warn those intending to cross the aviation runway or to otherwise enter the aviation runway of possible runway conflicts. Additionally, in at least some embodiments, the runway status light sub-systems 40 further include runway status lights 350 that are operated to provide an indication of runway occupancy to aircraft that are in the air preparing to land or aircraft that have entered the runway and are preparing to depart, referred to herein as Departure and Approach Warning Lights (DALs). In general, DALs would be installed at the ends of the aviation runways to warn aircraft preparing for landing or preparing for departure of possible runway conflicts.

FIG. 4B shows a runway status light configuration for a small aviation runway 190. As can be seen, the aviation runway 190 includes six different entrances arranged along its length. In each case, a runway status light 350A is installed on a left-hand side of the entrance to the aviation runway, which is operated as an REL by respective runway status light sub-system 40. In this way, as aircraft and vehicles approach the entrance to the runway, the RELs 350A provide an easy indication of whether the aviation runway is occupied such that the aircraft or vehicles should wait before entering or crossing the aviation runway. Additionally, at each end of the aviation runway, a runway status light 350B is installed on a right-hand side, which is operated as a DAL by a respective runway status light sub-system 40. In this way, an aircraft preparing to land is provided with an easy indication of whether the aviation runway is occupied such that the aircraft should not land. Likewise, an aircraft located at the end of the aviation runway preparing for takeoff is provided with an easy indication of whether the aviation runway is occupied such that the aircraft should not attempt takeoff.

The runway status lights 350 can take any practical form, including as in-pavement lights with on-pavement fixtures as currently used as runway status lights in the United States, or as stop bars, currently used in multiple countries around the world. It some embodiments, runway guard lights (RGLs) or simple stop bar lights may be modified to also provide stop signals to aircraft, vehicles, and pedestrians entering a runway. The elimination of in-pavement lighting and the use of existing light fixtures reduces the cost and complexity of the installation and would be particularly beneficial at non-towered and general aviation airports with relatively narrow taxiways, where taxiway edges are often within a pilot's, driver's, or pedestrian's field of view. They also offer a low-cost option when users are aware of potential conflicts and know what to look for, and at less frequently used crossings, where high costs are difficult to justify.

FIG. 4C shows an exemplary fixture 360 having two runway status lights 350, which is similar to some existing runway guard lights. As can be seen, the runway status lights 350 are arranged adjacent to one another within supportive housing 370 that elevates the runway status lights 350 from the ground. In one embodiment, the runway status lights 350 are configured to flash red to indicate that an aircraft should stop and hold at a runway entrance due to a potentially conflicting aircraft on the runway. When no conflict is detected, the runway status lights 350 are configured to flash yellow, thus returning to operation in a similar manner as conventional runway guard lights. In some embodiments, the fixture 360 may be installed adjacent to existing aviation runway signage 380, as shown in FIG. 4D, as pilots and other airport personnel are already accustomed to looking at these locations. The use of flashing yellow and red lights to indicate “caution” and “stop” respectively, should be intuitive for most pilots who also drive. However, it should be appreciated that any suitable lighting control and color scheme can be adopted.

If a runway entrance is already equipped with an RGL, a replacement RGL/REL can be installed with a simple swap out. Due to wireless capabilities, no additional wiring would be needed. However, as RGLs are only required at the entrances of runways with precision approaches, it is expected that most installation locations will not be equipped with already existing RGLs.

In some embodiments, the proposed installation and positioning of the RELs is the same as is currently recommended for elevated RGLs per FAA Advisory Circular (AC) 150/5340-30J. The colocation of the RELs/RGLs with the runway holding position markings will be appropriate for indicating to approaching aircraft the status of the runway. It is expected that pilots hold short of these markings when waiting and should also be able to view the lights to check the runway status when holding short.

In addition to RELs, the runway incursion avoidance system 10 will also include DALs that will be located on the opposite side of the runway from the approach lighting system (Precision Approach Path Indicator (PAPI) or Visual Approach Slope Indicator (VASI)), if installed, or on either side of the runway close to the touchdown zone markings. In some embodiments, DALs can be provided using a similar lighting fixture having only one runway status light 350. In this example, the runway status light 350 might flash red to indicate runway occupancy beyond the position of the DAL. This light will be visible to both approaching aircraft and departing aircraft to suggest the possible need to go-around, or standby for departure. Alternatively, FIG. 4E shows an embodiment in which high intensity runway status lights 350 are located across the runway and abeam any installed approach lighting 390, which are used to indicate runway status to landing aircraft. Angled lights with directional lenses can provide different indications to aircraft on the ground and in the air, providing indications for both arriving and departing aircraft simultaneously.

Of course, it should be appreciated that any number of alternative fixtures and installations can be adopted, as needed, to provide RELs and DALs. Accordingly, it should be understood that the examples described herein are merely exemplary.

### Methods for Operating the Runway Incursion Avoidance System

A variety of operations and processes are described below for operating the runway incursion avoidance system 10 to improve safety of an aviation runway at which the system is installed. In these descriptions, statements that a method, processor, and/or system is performing some task or function refers to a controller or processor (e.g., the processor 110 of the computer-vision surveillance sub-systems 20, the processor 210 of the ADS-B surveillance sub-system 30, or the processor 310 of the runway status light sub-systems 40) executing programmed instructions (e.g., the runway occupancy detection program 122 of the computer-vision surveillance sub-systems 20, the runway occupancy detection program 222 of the ADS-B surveillance sub-system 30, or the runway status indicator program 322 of the runway status light sub-systems 40) stored in non-transitory computer readable storage media (e.g., the memory 120 of the computer-vision surveillance sub-systems 20, the memory 220 of the ADS-B surveillance sub-system 30, or the memory 320 of the runway status light sub-systems 40) operatively connected to the controller or processor to manipulate data or to operate one or more components in the runway incursion avoidance system 10 to perform the task or function. Additionally, the steps of the methods may be performed in any feasible chronological order, regardless of the order shown in the figures or the order in which the steps are described.

The surveillance sub-systems 20, 30 are each configured to independently determine predictions of one or more of a plurality of occupancy states of the aviation runway corresponding to a plurality of defined regions of the aviation runway. Each defined region of the aviation runway is referred to herein as a detection volume. In at some embodiments, the detection volumes extend only a predetermined distance/altitude in to the airspace.

In each case, the respective occupancy state of a given detection volume is a binary (i.e., TRUE or FALSE) value that indicates whether the given detection volume is occupied. In some embodiments, the occupancy state is TRUE only when an object, such as an aircraft, vehicle, pedestrian, wild animal, or other foreign object, is currently located within the detection volume. However, in other embodiments, the occupancy state is also TRUE if the detection volume will be occupied by an object within a predetermined amount of time. In further embodiments, the occupancy state may be ternary value having three possible states indicating that the detection volume is currently occupied, that the detection volume will be occupied by an object within a predetermined amount of time, or that the detection volume is not occupied (and will not be within the predetermined amount of time). It should be appreciated that the detection volumes around an aviation runway may be defined in any arbitrary manner.

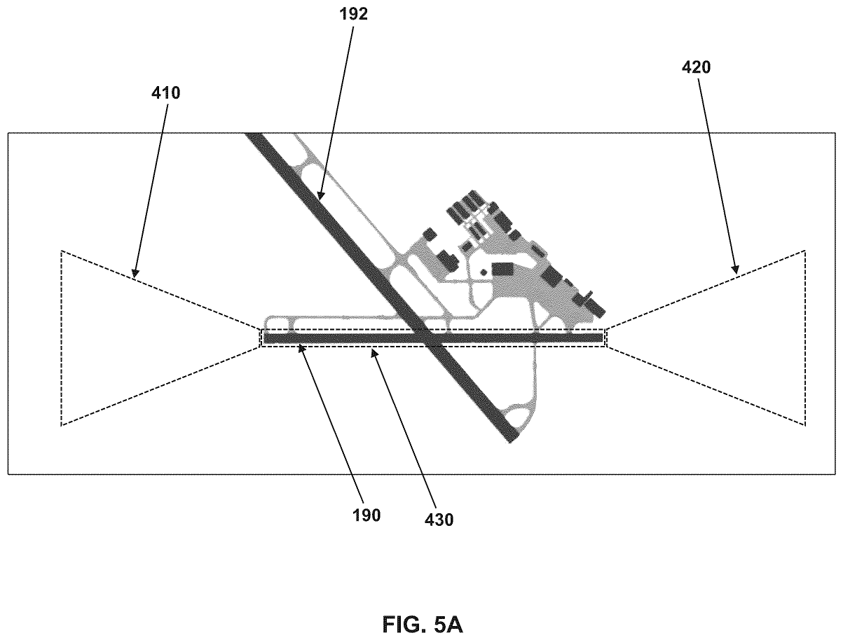

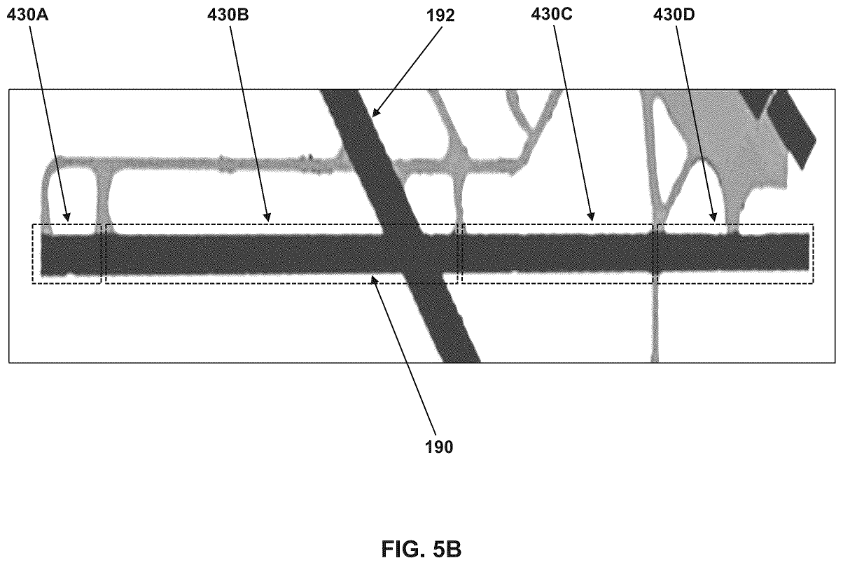

FIG. 5A shows one example in which an aviation runway 190 is divided in to three detection volumes. Particularly, a first detection volume 410 captures a first approach of the aviation runway 190 at an end of the aviation runway 190. A second detection volume 420 captures a second approach of the aviation runway 190 at an opposite end of the aviation runway 190. Finally, a third detection volume 430 captures a surface of the aviation runway 190. As can be seen, a further aviation runway 192 intersects with the aviation runway 190. It should be appreciated that the runway incursion avoidance system 10 may define similar detection volumes for the further aviation runway 192 in a similar manner (not shown).

FIG. 5B shows a further example in which the surface of an aviation runway 190 is subdivided in to four detection volumes. Particularly, a first surface detection volume 430A captures a first defined section of the surface of the aviation runway 190. A second surface detection volume 430B captures a second defined section of the surface of the aviation runway 190. A third surface detection volume 430C captures a third defined section of the surface of the aviation runway 190. A fourth surface detection volume 430C captures a fourth defined section of the surface of the aviation runway 190. It should be appreciated that the division of the surface of the aviation runway 190 may be defined in any arbitrary manner. In some embodiments, the runway incursion avoidance system 10 may define similar detection volumes for the further aviation runway 192 in a similar manner and including, for example, a shared detection volume at the intersection of the aviation runway 190 with the further aviation runway 192 (not shown).

Dividing the surface of the aviation runway into multiple sections allows for runway status to be presented timelier and more accurately to aircraft, vehicles, and pedestrians holding short of different portions of the runway. For example, with two surface sections, one in each direction of a hold short line (left or right), a runway status light at a runway entrance can extinguish its indication as soon as the aircraft passes that point, rather than when the aircraft exits the runway.

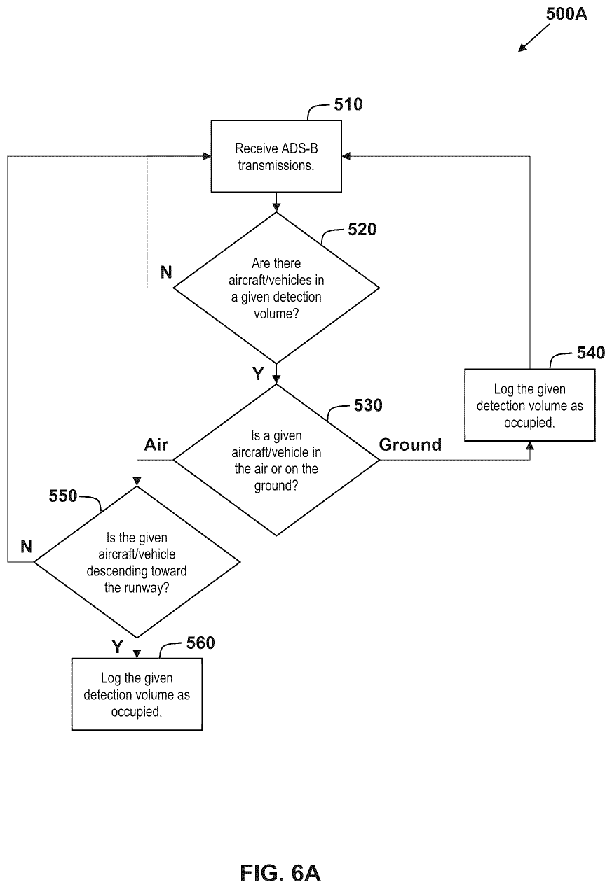

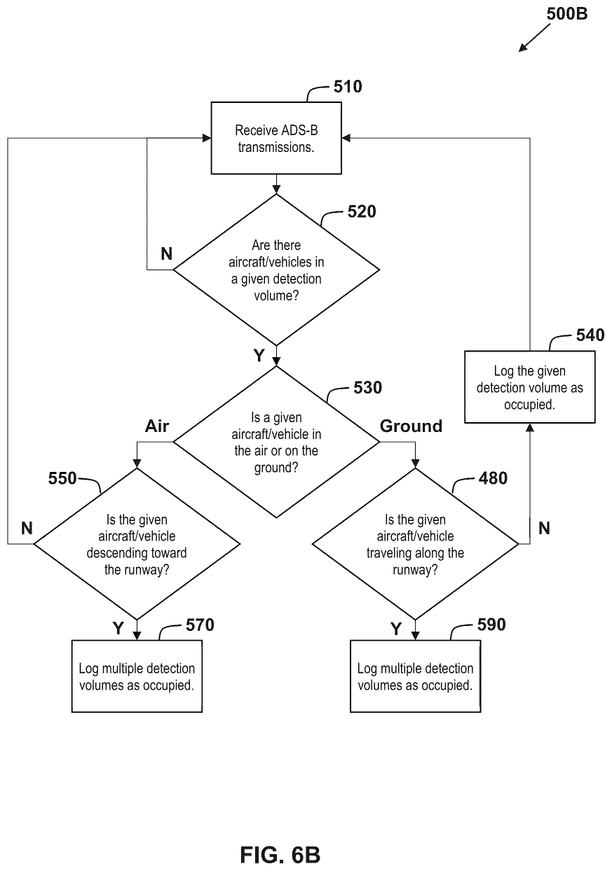

FIG. 6A shows a flow diagram for a method 500A for operating an ADS-B surveillance subsystem to monitor one or more detection volumes. Particularly, the processor 210 of the ADS-B surveillance sub-system 30 operates the ADS-B receiver 250 to receive ADS-B transmission from any ADS-B equipped aircraft or vehicles within range, which include traffic information (block 510). The traffic information received from each respective aircraft or ground vehicle includes, for example, aircraft/vehicle identification information, a ground speed of the aircraft/vehicle, a ground track (direction of travel) of the aircraft/vehicle, and a GPS location (latitude and longitude) of the aircraft/vehicle. However, as previously mentioned, in some embodiments, the ADS-B receiver 250 is configured to receive traffic information using a variety of other surveillance and communications systems, such as Mode S. Accordingly, references herein to ADS-B should be understood to also include any other suitable technologies for receiving traffic information from aircraft and ground vehicles.

Based on the traffic information, for each detection volume monitored by the ADS-B surveillance sub-system 30, the processor 210 determines whether any aircraft or vehicles are located in the given detection volume (block 520). The processor 210 determines if an aircraft or vehicle is located in a detection volume based on the reported position and/or pressure altitude from ADS-B transmissions. In at least some embodiments, the processor 210 must correct the pressure altitude reported through ADS-B transmissions through a connected barometric pressure sensor for determination of the aircraft's altitude above ground level (AGL). In some embodiments, the processor 210 applies a Kalman filter and/or interpolation algorithm to increase the quality of the position data. In some embodiments, the processor 210 uses multilateration and/or time-based estimation to further increase accuracy of position data.

If no aircraft or vehicles are located in the given detection volume, then the processor 210 returns to block 510. However, for each aircraft or vehicle located in each detection volume, the processor 210 determines whether the aircraft or vehicle is in the air or on the ground (block 530). In one embodiment, the processor 210 determines whether the aircraft or vehicle is in the air or on the ground based on an altitude of the aircraft or vehicle.

If a given aircraft or vehicle located in a given detection volume is on the ground, then the processor 210 logs, for example in an occupancy log stored in the memory 220, a prediction that the detection volume is occupied at the current time (block 540). Otherwise, if a given aircraft located in a given detection volume is in the air, then the processor 210 determines whether the aircraft is descending toward the aviation runway to land (block 550). In one embodiment, the processor 210 determines whether the aircraft is descending toward the aviation runway to land based on a change in altitude over time and direction of travel (ground track) reported by the aircraft. In one embodiment, the processor 210 determines that an aircraft is descending toward the aviation runway in response to its direction of travel being within 45 degrees of a direction of the aviation runway and the altitude of the aircraft decreasing over time.

If a given aircraft located in a given detection volume is descending toward the aviation runway, then the processor 210 logs a prediction that the detection volume is occupied at the current time (block 560). Otherwise, if a given aircraft located in a given detection volume is not descending toward the aviation runway, then the processor 210 does not log a prediction that the detection volume is occupied and returns to block 510. In this way, departing aircraft that have already lifted off from the aviation runway are not logged as occupying an approach detection volume.

It should be appreciated that, in the method 500A, the ADS-B surveillance sub-system 30 only logs a prediction that a detection volume is occupied if an ADS-B aircraft or vehicle is currently located in the detection volume. In such embodiments, the runway status light sub-systems 40 are individually responsible for accounting for which detection volumes are likely to be occupied within a predetermined amount of time based on a direction of travel of the detected aircraft or vehicles, for the purpose of controlling the runway status lights proactively. However, in some embodiments, the ADS-B surveillance sub-system 30 may be configured to handle this function and log predictions for detection volumes that will soon be occupied within a predetermined amount of time.

FIG. 6B shows a flow diagram for a further method 500B for operating an ADS-B surveillance subsystem to monitor one or more detection volumes, including forecasting future occupancy of other detection volumes. The processes of blocks 510, 520, 530, 540, and 550 are essentially similar to that of the method 500A, and are not described in detail again. However, if at block 550 it is determined that a given aircraft located in a given detection volume is descending toward the aviation runway, then the processor 210 logs a prediction that multiple detection volumes are occupied at the current time (block 570). In particular, the processor 210 logs a prediction that the detection volume in which the aircraft is located is occupied and also logs that one or more additional detection volumes in the direction of travel of the aircraft are also occupied because they are likely to be occupied within a predetermined amount of time. In one example, the processor 210 determines that an aircraft is located in an approach detection volume and is descending toward the runway to land. Based on this determination, the processor 210 logs a prediction that the approach detection volume is occupied and also logs a prediction that each of the runway surface detection volumes are also occupied.

Similarly, if at block 530 it is determined that a given aircraft or vehicle located in a given detection volume is on the ground, then the processor 210 next determines whether the aircraft or vehicle is traveling along the aviation runway (block 580). In one embodiment, the processor 210 determines that an aircraft or vehicle is traveling along the aviation runway in response to its direction of travel being within 45 degrees of a direction of the aviation runway. If the aircraft or vehicle is traveling along the aviation runway, then the processor 210 logs a prediction that multiple detection volumes are occupied at the current time (block 590). In particular, the processor 210 logs a prediction that the detection volume in which the aircraft or vehicle is located is occupied and also logs that one or more additional detection volumes in the direction of travel of the aircraft are also occupied because they are likely to be occupied within a predetermined amount of time. In one example, the processor 210 determines that an aircraft is located in a particular surface detection volume and is traveling along the aviation runway. Based on this determination, the processor 210 logs a prediction that the particular surface detection volume is occupied and also logs a prediction that each of the surface detection volumes along the aviation runway ahead of the aircraft or vehicle are also occupied. Otherwise, if the aircraft or vehicle is not traveling along the aviation runway, then the processor 210 only logs a prediction that the particular detection volume is occupied (block 540).

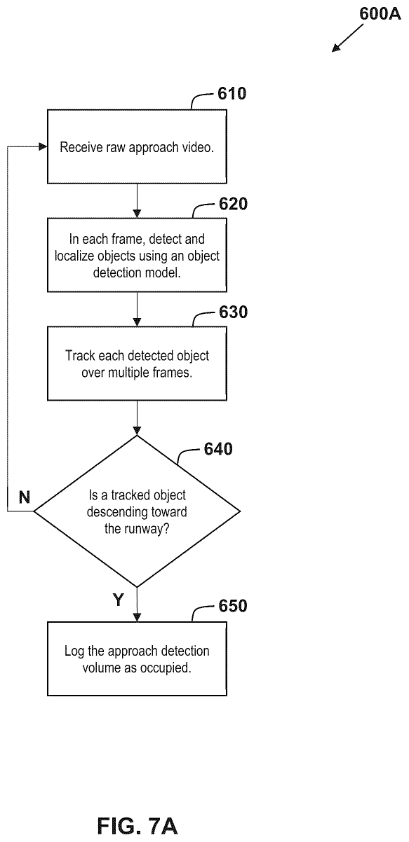

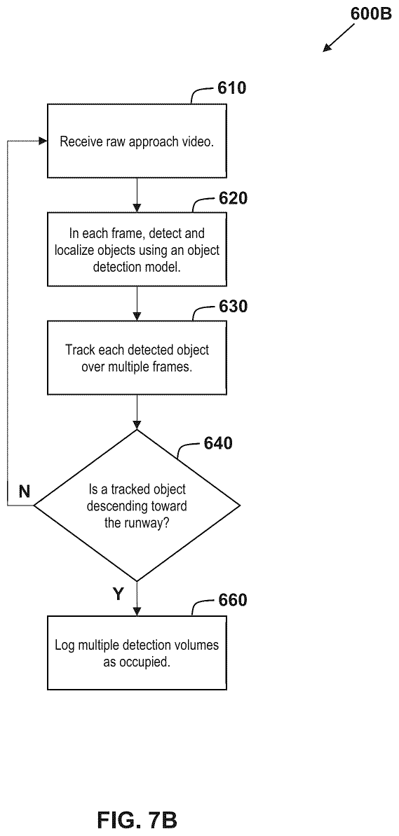

FIG. 7A shows a flow diagram for a method 600A for operating a computer-vision surveillance subsystem to monitor a runway approach detection volume. Particularly, the processor 110 of the computer-vision surveillance sub-system 20 operates the runway approach camera 22A to capture raw video of the approach of the aviation runway (block 610). Next, the processor 110 executes an object recognition model to detect and localize objects in the captured video using an object recognition model (block 620). In at least one embodiment, the object recognition model is a Convolutional Neural Network, or other state-of-the-art machine learning based model, which receives image frames from the video and outputs predictions of objects located in the image frame. In at least some embodiments, the predictions take the form of bounding boxes, each having a location, a height, and a width. Based on the height and width of the respective bounding box, the processor 110 determines a size or shape of each tracked object.

The processor 110 tracks the locations and sizes of the detected objects over time, i.e., over sequential frames of the video (block 630). Based on the locations and sizes of the detected objects over time, the processor 110 determines whether any of the detected objects are descending toward the aviation runway (block 640). In one embodiment, the processor 110 analyzes the apparent motion and rate of change in size over sequential frames of the detected aircraft to determine the direction of travel of the object. If the direction of travel is in the direction of the aviation runway and is descending over time, then the processor 110 determines that the object is descending toward the aviation runway. In one example, a gradual increase in size of the object and downward movement within the image frames is indicative of a direction of travel that is descending toward the aviation runway. In another example, a gradual decrease in size of the object and an upward movement within the image frames is indicative of a direction of travel that is ascending away from the aviation runway. However, it should be appreciated that the determination of the direction of travel is dependent upon the installation location and camera angle of the runway approach camera 22A.

If a given object detected in the approach detection volume is descending toward the aviation runway, then the processor 110 logs, for example in an occupancy log stored in the memory 120, a prediction that the approach detection volume is occupied at the current time (block 650). Otherwise, if a given object detected in the approach detection volume is not descending toward the aviation runway, then it is ignored and the processor returns to block 610. In this way, the tracked motion of the detections also serves to filter out false targets such as birds, which look similar to aircraft but move differently.

As similarly discussed above with respect to the method 500A, the method 600A only logs a prediction that a detection volume is occupied if an object is currently located in the detection volume. In such embodiments, the runway status light sub-systems 40 are individually responsible for accounting for which other detection volumes are likely to be occupied within a predetermined amount of time based on a direction of travel of the detected object, for the purpose of controlling the runway status lights proactively. However, in some embodiments, the computer-vision surveillance sub-system 20 may be configured to handle this function and log predictions for detection volumes that will soon be occupied within a predetermined amount of time.

FIG. 7B shows a flow diagram for a further method 600B for operating a computer-vision surveillance subsystem to monitor a runway approach detection volume, including forecasting future occupancy of other detection volumes. The processes of blocks 610, 620, 630, and 640 are essentially similar to that of the method 600A, and are not described in detail again. However, if at block 640 it is determined that a given object detected in the approach detection volume is descending toward the aviation runway, then the processor 210 logs a prediction that multiple detection volumes are occupied at the current time (block 660). In particular, the processor 210 logs a prediction that the approach detection volume in which the object is located is occupied and also logs that one or more additional detection volumes in the direction of travel of the object are also occupied because they are likely to be occupied within a predetermined amount of time. In one example, in response to an aircraft descending toward the aviation runway in an approach detection volume, the processor 210 logs a prediction that the approach detection volume is occupied and also logs a prediction that each of the runway surface detection volumes are also occupied.

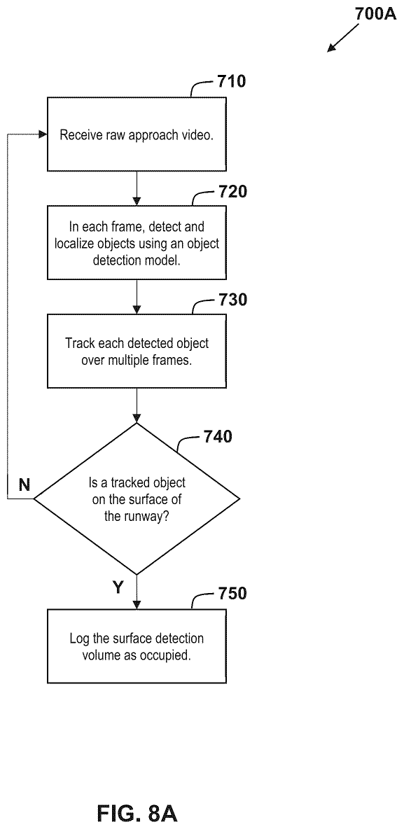

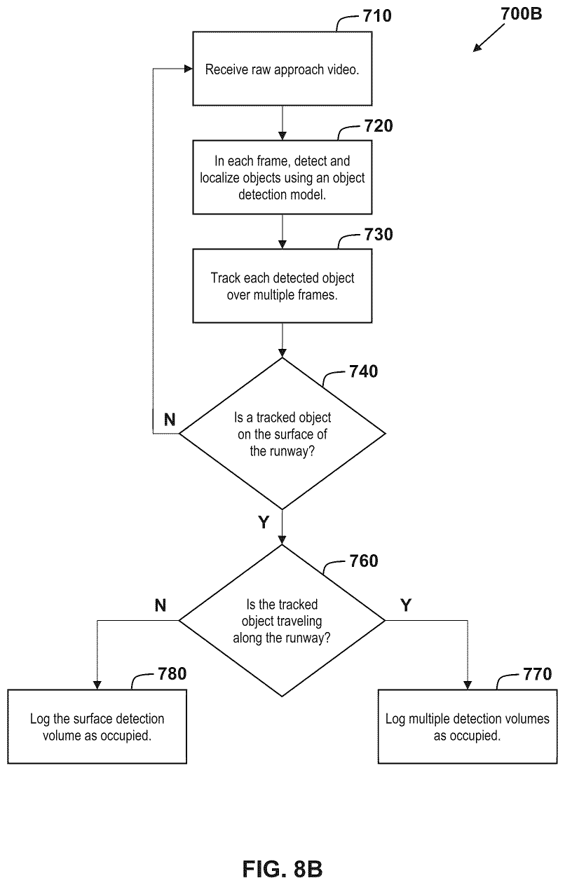

FIG. 8A shows a flow diagram for a method 700A for operating a computer-vision surveillance subsystem to monitor a runway surface detection volume. Particularly, the processor 110 of the computer-vision surveillance sub-system 20 operates the runway surface camera 22B to capture raw video of the surface of the aviation runway (block 710). Next, the processor 110 executes an object recognition model to detect and localize objects in the captured video using an object recognition model (block 720). The processor 110 tracks the locations and sizes of the detected objects over time, i.e., over sequential frames of the video (block 730). Based on the tracked locations, the processor 110 determines whether any objects are located on the surface of the runway, within one of the surface detection volumes (block 740). If any given object is determined to be located in a given runway surface detection volume, then the processor 110 logs, for example in an occupancy log stored in the memory 120, a prediction that the given runway surface detection volume is occupied at the current time (block 750).

As similarly discussed above with respect to the methods 500A and 600A, the method 700A only logs a prediction that a detection volume is occupied if an object is currently located in the detection volume. In such embodiments, the runway status light sub-systems 40 are individually responsible for accounting for which other detection volumes are likely to be occupied within a predetermined amount of time based on a direction of travel of the detected object, for the purpose of controlling the runway status lights proactively. However, in some embodiments, the computer-vision surveillance sub-system 20 may be configured to handle this function and log predictions for detection volumes that will soon be occupied within a predetermined amount of time.

FIG. 8B shows a flow diagram for a further method 700B for operating a computer-vision surveillance subsystem to monitor a runway surface detection volume, including forecasting future occupancy of other detection volumes. The processes of blocks 710, 720, 730, and 740 are essentially similar to that of the method 700A, and are not described in detail again. However, if at block 740 it is determined that any object is located in a runway surface detection volume, then the processor 110 determines whether the object is traveling along the aviation runway (block 760). In one embodiment, the processor 110 analyzes the apparent motion and rate of change in size over sequential frames of the detected object to determine the direction of travel of the object. In one embodiment, the processor 110 determines that an object is traveling along the aviation runway in response to its direction of travel being within 45 degrees of a direction of the aviation runway.

If the object is traveling along the aviation runway, then the processor 110 logs a prediction that multiple detection volumes are occupied (block 770). In particular, the processor 110 logs a prediction that the detection volume in which the object is located is occupied and also logs that one or more additional detection volumes in the direction of travel of the object are also occupied because they are likely to be occupied within a predetermined amount of time. In one example, the processor 110 determines that an object is located in a particular surface detection volume and is traveling along the aviation runway. Based on this determination, the processor 110 logs a prediction that the particular surface detection volume is occupied and also logs a prediction that each of the surface detection volumes along the aviation runway ahead of the object are also occupied. Otherwise, if the object is not traveling along the aviation runway, then the processor 110 only logs a prediction that the particular detection volume in which the object is located is occupied (block 780).

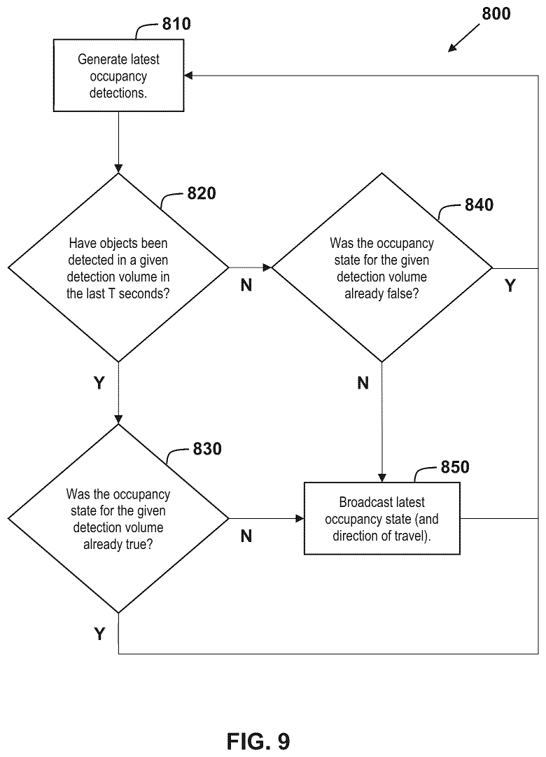

FIG. 9 shows a flow diagram for a method 800 for operating a surveillance sub-system to broadcast occupancy states of a detection volume. Particularly, the surveillance sub-systems 20, 30 operate to generate predictions of occupancy states of one or more detection volumes of the aviation runway, for example using the computer-vision or ADS-B based methods discussed above (block 810). For the purpose of broadcasting updated occupancy states, for each detection volume that is monitored by a respective surveillance sub-system 20, 30, the processor 110, 210 determines whether objects have been detected in the respective detection volume in the last T seconds (block 820). If objects have been detected within the last T seconds, then the processor 110, 210 checks whether the occupancy state for the respective detection volume was already TRUE, i.e., occupied (block 830). If the occupancy state for the respective detection volume was already TRUE, then no update is required and the processor 110, 210 returns to block 810. Otherwise, if the occupancy state for the respective detection volume was not already TRUE, then the processor 110, 210 updates the occupancy state and operates the network communications module 130, 230 to broadcast the updated occupancy state of TRUE (block 850).

In at least some embodiments, in addition to broadcasting an updated occupancy state of TRUE at block 850, the processor 110, 210 also operates the network communications module 130, 230 to broadcast a direction of travel of each object detected in a given detection volume. As discussed above, in some embodiments, the runway status light sub-systems 40 are individually responsible for accounting for which detection volumes are likely to be occupied in the near future based on a direction of travel of the detected aircraft or vehicles, for the purpose of controlling the runway status lights proactively. In many cases, the direction of travel of detected objects is a necessary item of information for such control of runway status lights.

If at block 820, no objects have been detected within the last T seconds, then the processor 110, 210 checks whether the occupancy state for the respective detection volume was already FALSE, i.e., not occupied (block 840). If the occupancy state for the respective detection volume was already FALSE, then no update is required and the processor 110, 210 returns to block 810. Otherwise, if the occupancy state for the respective detection volume was not already FALSE, then the processor 110, 210 updates the occupancy state and operates the network communications module 130, 230 to broadcast the updated occupancy state of FALSE (block 850).

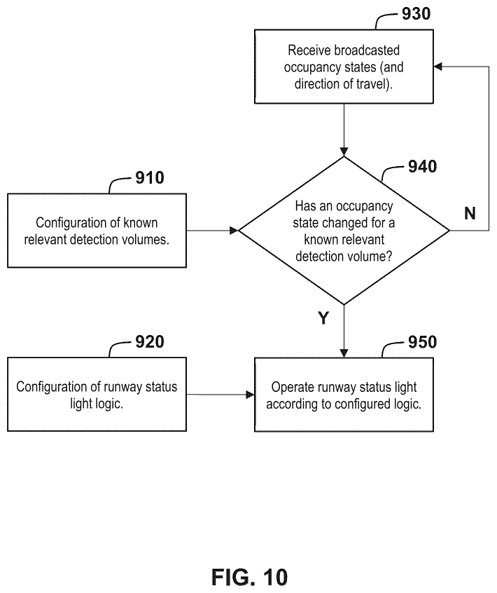

FIG. 10 shows a flow diagram for a method 900 for operating a runway status light sub-system to provide runway status indication. Particularly, the processor 310 of a runway status light sub-system 40 receives configuration information of known relevant detection volumes (block 910) and of suitable logic for operating the runway status lights 350 (block 920). This configuration information identifies the respective detection volumes that are relevant to the operation of the particular runway status light sub-system 40, and for which the occupancy states thereof should be monitored. Moreover, the configuration information specifies the logic that should be used to process the occupancy states of the known relevant detection volumes, and the directions of travel of detected objects therein, to determine when and how to operate the runway status lights 350. In at least some embodiments, the logic takes the form of combinational logic that is evaluated based on the current occupancy states of the known relevant detection volumes, and the directions of travel of detected objects therein, to determine whether a respective runway status light 350 should be operated in a particular mode of operation (e.g., turned on, flashing, set to a particular color, etc.). The configuration information is generally provided after installation and before operation. However, the configuration information can likewise be provided at any time to reconfigure a runway status light sub-system 40.

Once in operation, the processor 310 operates the network communications module 330 to receive the broadcasted occupancy states from the surveillance sub-systems 20, 30 (block 930). Additionally, in at least some embodiments, in addition to receiving updated occupancy states, the processor 310 operates the network communications module 330 to receive a direction of travel of each object detected in each occupied detection volume.

After each broadcast of updated occupancy states is received, the processor 310 checks whether any of the known relevant detection volumes (as identified in the configuration information) have had a change in their occupancy state (block 940). It should be appreciated that the runway status light sub-system 40 may receive updated occupancy states and direction of travel information from multiple different surveillance sub-systems 20, 30 that monitor the same detection volumes. If any surveillance sub-system 20, 30 reports that a particular detection volume is occupied, then the runway status light sub-system 40 considers the detection volume to be occupied. If there have been no changes, then the mode of operation of the runway status lights need not be changed and the processor 310 returns to block 930. Otherwise, if there has been a change in occupancy state of a known relevant detection volume, then the processor 310 updates the mode of operation of each runway status light in the respective runway status light sub-system 40 according to the logic identified in the configuration information.

In some embodiments, each runway status light 350 is configured such that when relevant detection volumes have a positive detection, the light will accordingly indicate a stop signal. A positive signal from only one relevant detection volume and one type of surveillance method is required for an indication. Thus, if only one of two modules covering a specific detection volume detect a conflict, the light will provide a stop signal. In some embodiments, received signals will instruct the appropriate RELs or DALs to switch color from yellow to red. While this is not possible with traditional incandescent RGL fixtures due to the use of lenses for color, this would be possible with LED RGLs installed with color changing (RGB) LEDs.

A wide variety of different logic may be applied by each runway status light sub-system 40 to operate a respective runway status light 350 to warn of potential traffic conflicts. In particular, the mode of operation of each respective runway status light 350 is controlled by the processor 310 depending on the occupancy states of the known relevant detection volumes and, at least in some embodiments, based on the direction of travel of objects occupying the known relevant detection volumes.

In one embodiment, the processor 310 operates a runway status light 350 in a particular mode of operation (e.g., turned on, flashing, set to a particular color, etc.) in response to a specific detection volume being occupied. For example, a runway status light 350 installed at an entrance of the aviation runway, i.e. as an REL, might be operated in a particular mode of operation in response to a nearby runway surface detection volume being occupied.

In another embodiment, the processor 310 operates a runway status light 350 in a particular mode of operation in response to any one of a defined set of detection volumes being occupied (i.e., using OR operator-based logic). For example, a runway status light 350 installed near the end of the aviation runway, i.e. as a DAL, might be operated in a particular mode of operation in response to any of the runway surface detection volumes being occupied or the runway approach detection volume being occupied.

In another embodiment, the processor 310 operates a runway status light 350 in a particular mode of operation in response to all of a defined set of detection volumes being occupied (i.e., using AND operator-based logic).

In another embodiment, the processor 310 operates a runway status light 350 in a particular mode of operation in response to a specific detection volume being occupied while the occupying object is traveling in a particular direction. For example, a runway status light 350 installed at an entrance of the aviation runway, i.e. as an REL, might be operated in a particular mode of operation in response to a runway surface detection volume further down the aviation runway being occupied, while the object is traveling along the aviation runway in a direction of the runway status light 350. In this way, aircraft and vehicles at a given intersection of the aviation runway will be warned if an object is traveling along the runway toward the intersection. In contrast, if the object is not traveling along the runway toward the intersection or has already passed the intersection, then the aircraft and vehicles at the intersection needn't be warned. In an example including intersecting aviation runways, a runway status light 350 installed at an end of the aviation runway, i.e. as a DAL, might be operated in a particular mode of operation in response to a detection volume of an intersecting aviation runway being occupied.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A system for aviation runway safety, the system comprising:
a plurality of surveillance modules, each surveillance module including a respective processor and a respective transmitter, the respective processor of each surveillance module being configured to:
independently determine a respective prediction of an occupancy state of an aviation runway, the occupancy state indicating whether a defined region of the aviation runway at least one of (i) is currently occupied by an object and (ii) will be occupied by an object within a predetermined amount of time; and
operate the respective transmitter to broadcast the respective prediction of the occupancy state; and
a plurality of runway status light modules, each runway status light module including a respective processor, a respective receiver, and a respective runway status light, the respective processor of each runway status light module being configured to:
operate the receiver to receive the respective prediction of the occupancy state from each of the plurality of surveillance devices; and
operate the respective runway status light depending on the respective prediction of the occupancy state from each of the plurality of surveillance devices.

2. The system according to claim 1, the respective processor of each surveillance module in the plurality of surveillance modules being configured to:
independently determine at least one respective prediction of at least one of a plurality of occupancy states of the aviation runway, each occupancy state in the plurality of occupancy states indicating whether a respective one of a plurality of defined regions of the aviation runway at least one of (i) is currently occupied by an object and (ii) will be occupied by an object within a predetermined amount of time.

3. The system according to claim 2, wherein the plurality of defined regions of the aviation runway includes (i) a first approach of the aviation runway, (ii) a surface of the aviation runway, and (iii) a second approach of the aviation runway.

4. The system according to claim 3, wherein the plurality of defined regions of the aviation runway includes a plurality of defined sections of the surface of the aviation runway.

5. The system according to claim 2, wherein a first surveillance module of the plurality of surveillance modules includes at least one camera, the respective processor of the first surveillance module being configured to:
receive video of the aviation runway from the at least one camera; and
determine the at least one respective prediction of the at least one of the plurality of occupancy states based on the video.

6. The system according to claim 5, wherein the at least one camera includes a first camera arranged to capture first video of a surface of the aviation runway, a first defined region of the plurality of defined regions including the surface of the aviation runway, the respective processor of the first surveillance module being configured to:
detect objects in the first video using an object recognition model;
determine whether the detected objects are located in the first defined region; and
determine a respective first prediction of a first occupancy state of the first defined region based on whether any objects are located in the first defined region.

7. The system according to claim 6, the respective processor of the first surveillance module being configured to:
determine whether any of the detected objects located in the first defined region are traveling along the aviation runway; and
determine a respective further prediction of a further occupancy state of a further defined region in the plurality of defined regions based on whether any of the detected objects located in the first defined region are traveling along the aviation runway.

8. The system according to claim 5, wherein the at least one camera includes a second camera arranged to capture second video of an approach of the aviation runway, a second defined region of the plurality of defined regions including the approach of the aviation runway, the respective processor of the first surveillance module being configured to:
detect objects in the second video using an object recognition model;
determine whether the detected objects are located in the second defined region;
determine directions of travel of the detected objects in the second defined region; and
determine a respective second prediction of a second occupancy state of the second defined region based on the directions of travel of any objects that are located in the second defined region.

9. The system according to claim 8, the respective processor of the first surveillance module being configured to:
determine whether any of the detected objects located in the second defined region are descending toward the aviation runway; and
determine a respective further prediction of a further occupancy state of a further defined region in the plurality of defined regions based on whether any of the detected objects located in the second defined region are descending toward the aviation runway.

10. The system according to claim 2, wherein a second surveillance module of the plurality of surveillance modules includes receiver, the respective processor of the second surveillance module being configured to:
receive traffic information from the receiver, the traffic information including locations and altitudes of aircraft or vehicles; and
determine the at least one respective prediction of the at least one of the plurality of occupancy states based on the traffic information.

11. The system according to claim 10, wherein a first defined region of the plurality of defined regions of the aviation runway includes a surface of the aviation runway, the respective processor of the second surveillance module being configured to:
determine whether any aircraft or vehicles are located in the first defined region based on the traffic information; and
determine a respective first prediction of a first occupancy state of the first defined region based on whether any aircraft or vehicles are located in the first defined region.

12. The system according to claim 11, the respective processor of the second surveillance module being configured to:
determine whether any of the aircraft or vehicles located in the first defined region are traveling along the aviation runway; and
determine a respective further prediction of a further occupancy state of a further defined region in the plurality of defined regions based on whether any of the aircraft or vehicles located in the first defined region are traveling along the aviation runway.

13. The system according to claim 10, wherein a second defined region of the plurality of defined regions includes an approach of the aviation runway, the respective processor of the second surveillance module being configured to:
determine whether any of aircraft are located in the second defined region based on the traffic information; and
determine a respective second prediction of a second occupancy state of the second defined region based on whether any of the aircraft or vehicles are located in the second defined region.

14. The system according to claim 13, the respective processor of the second surveillance module being configured to:
determine whether any of the aircraft located in the second defined region are descending toward the aviation runway; and
determine a respective further prediction of a further occupancy state of a further defined region in the plurality of defined regions based on whether any of the aircraft located in the second defined region are descending toward the aviation runway.

15. The system according to claim 2, the respective processor of each runway status light module being configured to:
operate the receiver to receive the respective predictions of the plurality of occupancy states of the aviation runway from the plurality of surveillance modules, the respective predictions including multiple predictions of a first occupancy state of a first defined region in the plurality of defined regions received from multiple surveillance modules of the plurality of surveillance modules; and
operate the respective runway status light in a predetermined manner in response to any one of the multiple predictions of the first occupancy state indicating that the first defined region of the aviation runway at least one of (i) is currently occupied by an object and (ii) will be occupied by an object within a predetermined amount of time.

16. The system according to claim 2, the respective processor of each runway status light module being configured to:
operate the receiver to receive the respective predictions of the plurality of occupancy states of the aviation runway from the plurality of surveillance modules; and
operate the respective runway status light in a predetermined manner in response to the respective predictions of the plurality of occupancy states indicating that any of the plurality of defined regions of the aviation runway at least one of (i) are currently occupied by an object and (ii) will be occupied by an object within a predetermined amount of time.

17. The system according to claim 2, the respective processor of each surveillance module in the plurality of surveillance modules being configured to:
determine a direction of travel of each object occupying one of the plurality of defined regions; and
operate the respective transmitter to broadcast the direction of travel of each object occupying one of the plurality of defined regions.

18. The system according to claim 17, the respective processor of each runway status light module being configured to:
operate the receiver to receive the respective predictions of the plurality of occupancy states of the aviation runway from the plurality of surveillance modules;
operate the receiver to receive the direction of travel of each object occupying one of the plurality of defined regions; and
operate the respective runway status light in a predetermined manner depending on the respective predictions of at least one of the plurality of occupancy states and depending on the direction of travel of at least one object occupying one of the plurality of defined regions.

19. The system according to claim 18, the respective processor of each runway status light module being configured to:
operate the respective runway status light in a predetermined manner in response to (i) the respective predictions of the plurality of occupancy states indicating that a particular defined region of the plurality of defined regions of the aviation runway is currently occupied by an object and (ii) the direction of travel of the object is in a particular direction.

20. The system according to claim 1, at least one of the plurality of surveillance modules is further configured to at least one of:
count a number of aircraft landing on the aviation runway; and
count a number of aircraft taking off from the aviation runway.
